(19) United States
(12) Patent Application Publication
(10) Pub. No.: US 2009/0212502 A1
(43) Pub. Date: Aug. 27, 2009

(54) SEAL RING

(75) Inventors: Gilles BORDENET, Schiltigheim (FR); Yann PONTE, Illkirch (FR)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/370,498

(22) Filed: Feb. 12, 2009

(30) Foreign Application Priority Data
Feb. 13, 2008 (EP) 08002632.1-2422

(51) Int. Cl. F16J 15/00; B23P 17/00

(52) U.S. Cl. 277/500; 29/527.1

(57) ABSTRACT

A seal ring, especially for use in automatic transmissions is provided that tends to leak less than known seal rings. The seal ring is free from ejector pin traces on the sealing surface. Seal rings with improved sealability and pressure stability are provided when used in automatic transmissions, these seal rings improve the drivability and better pressure stability during the shifting.

### CROSS-REFERENCE TO RELATED APPLICATION

This application claims priority to European Patent Application No. 08002632.1-2422, filed Feb. 13, 2008, which is incorporated herein by reference in its entirety.

### TECHNICAL FIELD

The invention concerns a seal ring, and more particularly to a sealing ring for use in automatic transmissions.

### BACKGROUND

Seal rings are used in many technical fields. In automatic transmissions for example, seal rings are used in order to avoid hydraulic leakage between channels. As there are high pressures in the channels, imperfections of the seal rings lead to leakage between the channels.

Document CA 2 427 972 A1 describes a bellows seal for a quick connect coupling. The bellows seal has a toroidal portion with a substantially planar sealing surface at one end of the toroidal portion and a bellows portion at the other end of the toroidal portion. The bellows portion extends away from the toroidal portion and is semicircular in cross-section and terminates in a circumferential sealing bead at an apex of the bellows portion. The toroidal portion may have a metal reinforcement ring. The termination bead of the bellows portion has a part circular cross-section with a diameter greater than that of the thickness of the bellows portion.

It is known from U.S. Pat. No. 5,628,519 A, a seal ring is described having uniform dimensions over the entire length thereof. This is achieved by properly positioning the injection point for injecting a material when injection-molding the seal ring. More specifically, the injection point is angularly displaced from the center of the entire length of the seal ring by ±1° to ±30°.

In view of the foregoing, at least one objective of the invention is to provide a seal ring which tends less to leakage than known seal rings. In addition, other objectives, desirable features, and characteristics will become apparent from the summary and subsequent detailed description, and the appended claims, taken in conjunction with the accompanying drawings and this background.

### SUMMARY

The at least one objective, other objectives, desirable features, and characteristics, is attained according to an embodiment of the invention in that the seal ring is free from ejector pin traces on the sealing surface.

The consideration is taken into account that it is the presence of ejector traces, especially ejector pin marks, on the sealing surface of the seal ring to which the leakage is due. These ejector traces come from the injection process in which the seal ring is produced. Ejector pins are necessary in order to get the seal ring out of the cavity of the mould after the injection-molding. As ejector pins can not be avoided, the invention proposes therefore to displace the ejector pins from the sealing surface of the seal ring and to place them elsewhere improving thereby the flatness of the sealing surface. As they are no more on the sealing surface, they do not affect any more the seal-ability.

The embodiments of the invention provide seal rings with improved seal-ability and pressure stability. When used in automatic transmissions, these seal rings improve the drivability and better pressure stability during the shifting.

According to a preferred embodiment of the invention, the ejector pins are placed in the inner side of the seal ring. The ejector pins are removed from the sealing surface thereby allowing a flat surface without ejector pin traces or any burr on the outer side of the seal ring which is pressed against the housing in order to avoid any leakage.

In a preferred embodiment of the invention, the ejector pins are placed on tabs which are placed in recess areas on the inner side of the seal ring.

When the seal ring is out of the cavity of the mold, the tabs are cut and it may occur that burrs remain. Upon placing the tabs with the ejector pins in recess areas on the inner side of the seal ring, it is made sure that any remaining burrs are within the recess area where they do not disturb the function of the seal ring.

The embodiments of the invention also provide a process for fabricating a seal ring, especially for use in automatic transmissions, by injection-molding, with the following steps:

Providing a mold for a seal ring with a plurality of recesses in the inner side of the seal ring, in each recess a tab with an ejector pin being placed,

Injecting a material into the mold thereby injection-molding a seal ring,

When the seal ring is hardened, seizing the seal ring on the ejector pins and extracting the seal ring from the mold,

Cutting the tabs close to the wall of the inner side of the seal ring.

This process allows seal rings with a very flat sealing surface assuring good seal-ability.

### BRIEF DESCRIPTION OF THE DRAWINGS

The embodiments will hereinafter be described in conjunction with the following drawing figures, wherein like numerals denote like elements, and

FIG. 1a and FIG. 1b are schematic views of a seal ring according to an embodiment of the invention and a seal ring according to the prior art;

FIG. 2a and FIG. 2b are schematic views of a seal ring according to an embodiment of the invention and a seal ring according to the prior art placed between two channels in an automatic transmission.

### DETAILED DESCRIPTION

The following detailed description is merely exemplary in nature and is not intended to limit application and uses. Furthermore, there is no intention to be bound by any theory presented in the preceding background and summary or the following detailed description.

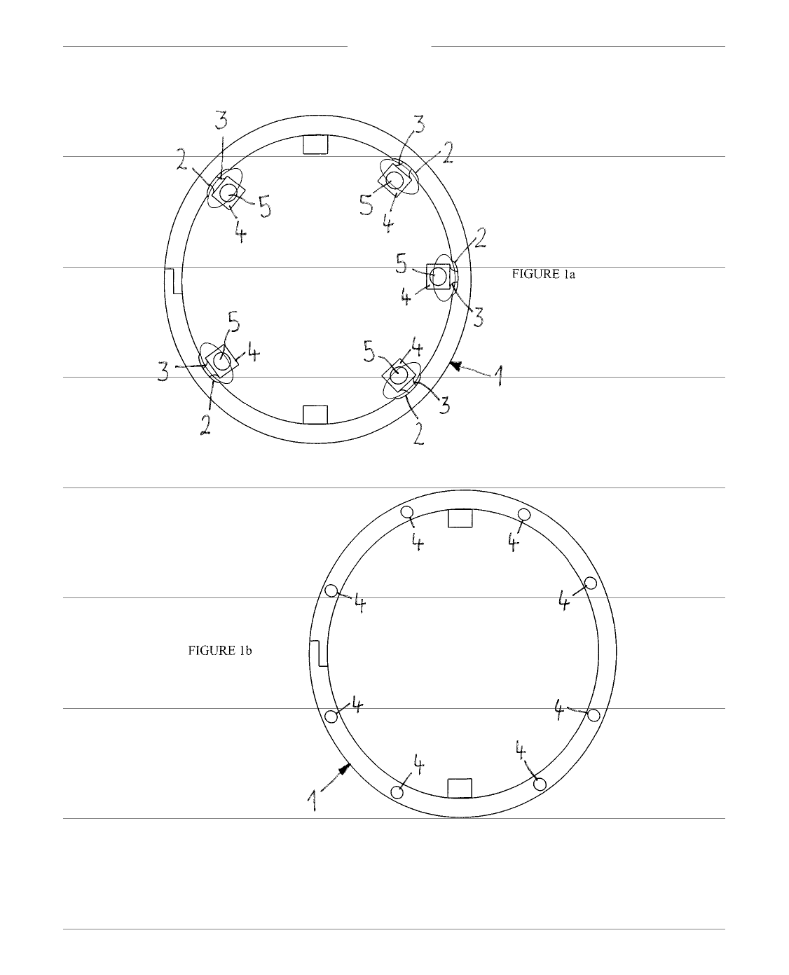

In FIG. 1a and FIG. 1b, the design of the seal ring in its injection-molded state is shown. It can be seen from FIG. 1a, that the seal ring 1 has a plurality of recesses 2 (here eight recesses as an example) regularly distributed over the inner surface of the seal ring. The recesses 2 have the shape of circle segments. In the middle of each recess 2, a tab 3 is placed at the free end of which an ejector pin 4 is formed. The ejector pins 4 have a central hole 5 which allows the ejector to seize the ejector pins 4 in order to extract the hardened seal ring 1 from the mold after injection-molding thereof.

FIG. 1b shows a seal ring 1 according to the prior art. On this seal ring 1, the ejector pins 4 are placed on the side of the seal ring 1. When they are cut after having used for seizing the seal ring 1 in order to extract it from the injection mold, ejector pin marks and burrs may remain on the surface of the seal ring 1 affecting the seal-ability thereof.

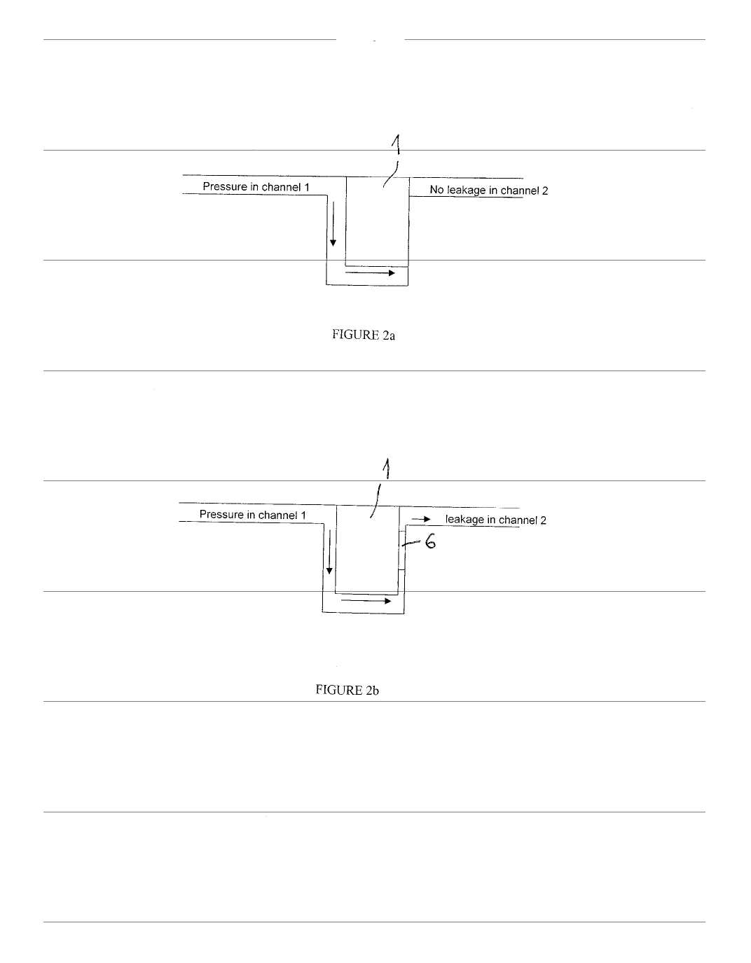

FIG. 2a shows a seal ring 1 according to an embodiment of the invention placed between two channels (channel one, channel two) of an automatic transmission. It can be seen from FIG. 2a that the seal ring 1 is pressed against the wall between channel one and channel two and thereby seals channel one from channel two with almost the whole sealing surface pressed against the wall.

Even if the hydraulic liquid in channel one is under high pressure, the seal ring 1 assures a good seal-ability.

FIG. 2b shows a seal ring 1 according to the prior art which is placed like the seal ring 1 of FIG. 2a in order to seal a channel one from a channel two. This seal ring 1 has an ejector trace 6 on its sealing surface (the surface which is pressed against the wall between channel one and channel two). Due to this ejector trace 6, there is a leakage between channel one and channel two.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A seal ring for an automatic transmission, comprising:
a sealing surface; and
a plurality of ejector pins having ejector pin traces that are free from the sealing surface.

2. The seal ring of claim 1, wherein the plurality of ejector pins are placed in an inner side of the seal ring.

3. The seal ring of claim 2, wherein the plurality of ejector pins are placed on a plurality of tabs that are placed in a plurality recess areas on the inner side of the seal ring.

4. A method for fabricating a seal ring for use in automatic transmissions, comprising the steps of
providing a mold for the seal ring with a plurality of recesses in an inner side of the seal ring;
placing a tab with an ejector pin in each of the plurality of recesses,
injecting a material into the mold thereby injection-molding the seal ring,
seizing the seal ring on the ejector pin in each of the plurality of recesses;
extracting the seal ring from the mold when the seal ring is hardened; and
cutting the tab with the ejector pin in each of the plurality of recesses close to a wall of the inner side of the seal ring.
